(19) United States
(12) Patent Application Publication
(10) Pub. No.: US 2005/0216947 A1
(43) Pub. Date: Sep. 29, 2005

(54) Upstream data bypass device for a video system

(76) Inventor: Scott A. Corbin, Stevens, PA (US)

Correspondence Address: BAKER & DANIELS LLP;111 E. WAYNE STREET, SUITE 800, FORT WAYNE, IN, 46802, US

(21) Appl. No.: 10/812,181

(22) Filed: Mar. 29, 2004

(51) Int. Cl. H04N 7/16; H04N 7/173; H04N 7/04

(52) U.S. Cl. 725/116; 725/146; 725/117

(57) ABSTRACT

A video system includes a video source transmitting an output signal on a transmission line. The output signal has a format such that first portions of the output signal include active video signals and second portions of the output signal lack active video signals. Each of a plurality of video receivers displays images based upon the active video signals and transmits a respective data signal on a respective one of a plurality of ports. A distribution device is electrically connected to the transmission line and to each of the ports. The distribution device transmits each of the data signals to the video source on the transmission line only during time periods when the second portions of the output signal are being transmitted on the transmission line. The distribution device includes a plurality of amplifiers, each having an input and an output. Each of the amplifiers receives signals on the input for transmission on the output as amplified signals. Each amplifier blocks signals received on the output from being transmitted on the input. Each amplifier transmits a respective amplified signal to a respective one of the receivers on a respective one of the ports. Each of the amplified signals is dependent upon the output signal and upon a data signal transmitted on the transmission line from the receivers other than the respective receiver.

### BACKGROUND OF THE INVENTION

1. Field of the Invention

The present invention relates to video data transmission systems, and, more particularly, to a bypass device for upstream video data transmission systems.

2. Description of the Related Art

Video systems commonly include an input video source, such as a camera, that transmits active video signals and data signals in a downstream direction to at least one output receiver, such as a video monitor. The receiver may receive both the active video signals and the data signals on a single, respective port. The video systems also often include one or more active devices, such as amplifiers, between the video source and the receiver. The amplifiers may operate to amplify, i.e., increase, the magnitude of, the active video signals and data signals so that the signals can be more readily used by the receiver.

It may be desirable to transmit data signals from the receiver to the video source in an upstream direction on the same port on which the downstream signals are transmitted. A problem is that active devices, such as amplifiers, typically allow signals to pass through them in only one direction. That is, an amplifier that amplifies signals in a downstream direction also blocks signals that are being transmitted in an upstream direction, such as from an output to an input. Thus, an amplifier does not allow data signals to be transmitted in an upstream direction from an output to an input on a same port on which downstream signals are carried from an input to an output.

Bypass equipment for bypassing active devices is necessary in order to transmit data signals in an upstream direction. Such bypass equipment allows the upstream-directed data to pass around active video equipment or transmission links to thereby reach the video source. Bypassing may be accomplished by extracting upstream data appearing at the output of the active device and then re-inserting the upstream data into the video system on the input side of the active device.

A problem is that bypass equipment that uses analog methods for extraction and re-insertion will insert not only data, but also some amount of noise into the video system. The noise is a result of imperfections in the data extraction process, poor termination quality, e.g., non-matching termination impedance at the monitor or some other video sink, and/or noise introduced into the video system at the video sink and its wiring. The noise degrades and distorts the active video signal, causing a loss of video fidelity in the display of the active video signal at the monitor. The noise may be more pronounced at the input of the video system where the upstream data is received by a video source. The noise at the input of the video system may be a particular problem in systems where a monitoring device, such as a monitor or digital video recorder (DVR) is connected at the input end of the system. Like the display of a monitoring device at the output end of the video system, the display of a monitoring device at the input end of the system would be distorted by the presence of noise.

Noise is an even greater problem in a distribution amplifier where upstream data from one output must be inserted on all other outputs. In this situation, the upstream data and its associated noise cannot be used to cancel itself out before it is transmitted downstream to the outputs. The noise problem worsens incrementally with each additional output. For example, in a 1-to-2 distribution amplifier, the noise from one other output channel would be added to each output; in a 1-to-3 distribution amplifier, the noise from two other output channels would be added to each output; in a 1-to-4 distribution amplifier, the noise from three other output channels would be added to each output; and so on.

What is needed in the art is a bypass device for a coaxial upstream data transmission system video system that reduces the effects of noise that is introduced into the active video signal as a result of data extraction and data insertion performed by the bypass device. That is, what is needed is a bypass device that reduces the distortion of the video image displayed on a monitor as caused by noise introduced into the video system by the bypass device.

### SUMMARY OF THE INVENTION

The present invention provides a bypass device for a coaxial upstream data transmission system video system that performs the data insertion during selected windows of time such that upstream data is inserted only on the portion of the video output signal that may carry data, and not on the portion of the video output signal that may carry a video image to be displayed on a screen. Thus, noise associated with the data extraction and insertion does not distort the video image that is displayed on the screen.

The invention comprises, in one form thereof, a video system including a video source transmitting an output signal on a transmission line. The output signal has a format such that first portions of the output signal include active video signals and second portions of the output signal lack active video signals. Each of a plurality of video receivers displays images based upon the active video signals and transmits a respective data signal on a respective one of a plurality of ports. A distribution device is electrically connected to the transmission line and to each of the ports. The distribution device transmits each of the data signals to the video source on the transmission line only during time periods when the second portions of the output signal are being transmitted on the transmission line. The distribution device includes a plurality of amplifiers, each having an input and an output. Each of the amplifiers receives signals on the input for transmission on the output as amplified signals. Each amplifier blocks signals received on the output from being transmitted on the input. Each amplifier transmits a respective amplified signal to a respective one of the receivers on a respective one of the ports. Each of the amplified signals is dependent upon the output signal and upon a data signal transmitted on the transmission line from the receivers other than the respective receiver.

The invention comprises, in another form thereof, a video system including a video source transmitting an output signal on a transmission line. The output signal has a format such that first portions of the output signal include active video signals and second portions of the output signal lack active video signals. Each of a plurality of video receivers displays images based upon the active video signals and transmits a respective data signal on a respective port. A distribution device is in electrical communication with the transmission line and with each of the ports. The distribution device transmits each of the data signals to the video source on the transmission line only during time periods when the second portions of the output signal are being transmitted on the transmission line. The distribution device includes a plurality of active devices, each transmitting a respective active-device-signal to a respective one of the receivers on a respective one of the ports. Each of the active-device-signals is dependent upon the output signal and upon at least one of the data signals transmitted on the transmission line from the receivers other than the respective receiver.

The invention comprises, in yet another form thereof, a video distribution apparatus including a first port electrically connected to a video source. The first port receives an output signal from the video source. The output signal has a format such that first portions of the output signal include active video signals and second portions of the output signal lack active video signals. Each of a plurality of second ports is electrically connected to a respective video receiver. Each of a plurality of active devices has an input and an output. Each output is electrically connected to a corresponding one of the second ports. Each input receives the output signal from the video source via the first port. Bypass circuitry includes a synchronization device identifying when the first portions of the output signal are received by the first port and when the second portions of the output signal are received by the first port. The bypass circuitry transmits data signals from each of the second ports to the first port and to the inputs of the active devices such that the data signals bypass the active devices. The first portions of the output signal are received by the first port during first periods in time. The data signals are received by the first port during second periods in time. The first periods in time and the second periods in time are mutually exclusive. The first portions of the output signal are received by the inputs of the active devices during third periods in time. The data signals are received by the inputs of the active devices during fourth periods in time. The third periods in time and the fourth periods in time are mutually exclusive.

The invention comprises, in a further form thereof, a video distribution apparatus including a first port electrically connected to a video source and receiving an output signal from the video source. The output signal has a format such that first portions of the output signal include active video signals and second portions of the output signal lack active video signals. A second port is electrically connected to a video receiver. An active device has an input and an output. The output is electrically connected to the second port. The input receives the output signal from the video source via the first port. Bypass circuitry includes a synchronization device identifying when the first portions of the output signal are received by the first port and when the second portions of the output signal are received by the first port. The bypass circuitry transmits data signals from the second port to the first port such that the data signals bypass the active device. The first portions of the output signal are received by the first port during first periods in time. The data signals are received by the first port during second periods in time. The first periods in time and the second periods in time are non-overlapping.

An advantage of the present invention is that display monitors connected to the video system are less affected by noise created by the data extraction and insertion of the bypass device.

Another advantage is that, when multiple video receivers send upstream data signals to each other, the active video signal transmitted to each of the video receivers is less corrupted and adversely affected by the noise that is created by the extraction and insertion of each of the upstream data signals.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a video system of the present invention.

FIG. 2 is a diagram of the format of one embodiment of a video output signal transmitted by the video source of FIG. 1.

FIG. 3 is a block diagram of another embodiment of a video system of the present invention.

FIG. 4A is a schematic diagram of a first section of one embodiment of the video distribution amplifier of the system of FIG. 3.

FIG. 4B is a schematic diagram of a second section of the video distribution amplifier of FIG. 4A.

FIG. 4C is a schematic diagram of a third section of the video distribution amplifier of FIG. 4A.

FIG. 4D is a schematic diagram of a fourth section of the video distribution amplifier of FIG. 4A.

FIG. 5 is a block diagram of yet another embodiment of a video system of the present invention, accommodating any number of video receivers.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

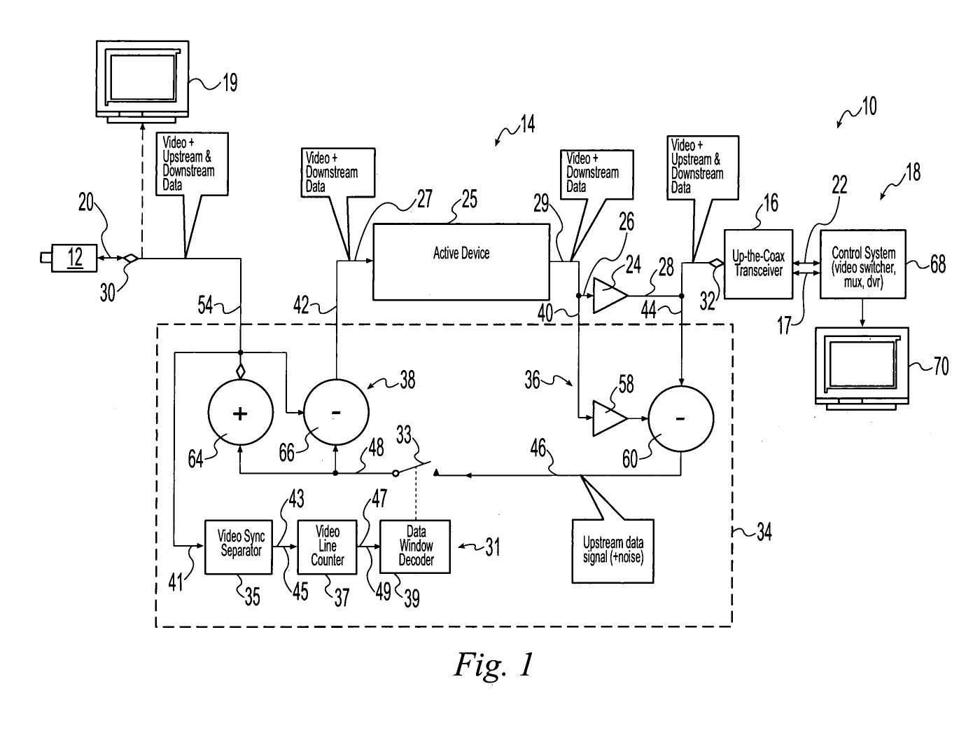

Referring now to the drawings and particularly to FIG. 1, there is shown one embodiment of a video system 10 of the present invention, including a video source 12, a video transmission apparatus (VTA) 14, an upstream coaxial type transceiver 16, an output-side video receiver 18, and an optional input-side monitor 19. Video source 12 may be in the form of a video camera with a transceiver for transmitting and receiving signals. That is, video source 12 may transmit a video output signal including active video signals and downstream data signals as well as receive upstream data signals via an associated transceiver. More particularly, the transceiver of video source 12 can transmit active video signals and downstream data signals on a first transmission line, which may be in the form of a first unshielded twisted pair (UTP) or first coaxial cable 20. Commonly used UTP type cables that may be used with the present invention include Cat-5, Cat-5e and Cat-6 cable. The optional monitor 19 may be connected to video source 12 on the input side of video system 10 so that monitor 19 can display the portion of the video output signal, e.g., the active video signal, that is produced by video source 12 for the benefit of an operator of video source 12.

The upstream and downstream data signals may include control data, configuration data, and other digital data. The active video signal and upstream and downstream data signals may be formatted in fields that enable the active video signals to be displayed as a series of horizontal video lines on the screen of a video receiver. The upstream and downstream data signals may be carried in the vertical blanking interval (VBI) of each field such that the data signals do not affect what is displayed on the screen.

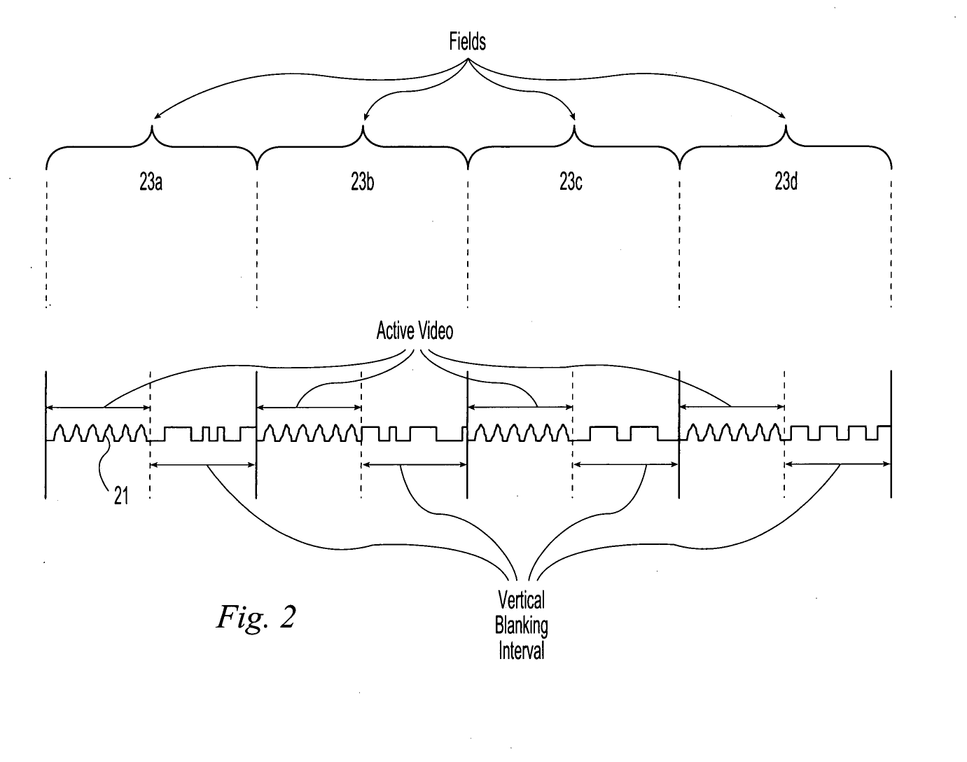

One embodiment of a video output signal of video source 12 is illustrated in FIG. 2 as a function of time. The video output signal may have a format such that the signal is divided into a plurality of fields 23. In one embodiment, each field 23 corresponds to a respective set of parallel horizontal lines that are displayed on any monitors that are connected to video system 10. Two fields form a full screen, with the horizontal lines from the two fields being interleaved on the screen. Each field 23 may have a first portion that includes an active video signal, and a second portion, such as the vertical blanking interval, that lacks an active video signal but instead includes a downstream data signal.

As mentioned above, the upstream data signal may include noise that is a result of imperfections in the data extraction process, poor termination quality, e.g., non-matching termination impedance at the monitor or some other video sink, and/or noise introduced into the video system at the video sink and its wiring. Such noise associated with the upstream data signals may interfere with the active video signals from the video source, thereby distorting the images displayed on the monitors connected to the video system. According to the present invention, the upstream data signals may be transmitted to video source 12 on cable 20 during time periods in which the active video signals are not being transmitted on cable 20. Thus, the distortion of and/or interference with the active video signal by the noise associated with the upstream data signals is reduced. For example, the upstream data signal could be transmitted during the same time periods allotted to the downstream data signals, as made possible by the present invention and described in more detail below. The downstream data signals and upstream data signals may be provided with different voltage levels and/or magnitudes so that the downstream and upstream data signals can be differentiated from each other even though they may be simultaneously received. Alternatively, it may be possible for the active video signals, downstream data signals and upstream data signals to be carried on cable 20 during mutually exclusive periods of time, thereby facilitating the differentiation of the signals. Further, it is possible for video source 12 to transmit only active video signals and perhaps some synchronization data, and not transmit downstream data signals. In this case, video source 12 could transmit active video signals and receive upstream data signals during separate, mutually exclusive, and/or alternating periods of time.

The active video signals and downstream data signals are generally passed to video receiver 18 via first cable 20, transmission apparatus 14, transceiver 16, a second transmission line in the form of a communications channel 17, which may be compatible with RS-232, RS-485, or Ethernet, for example, and a third transmission line in the form of a second UTP or second coaxial cable 22. The downstream data signals can be carried on channel 17, and the active video signals can be carried on cable 22. Video receiver 18 can transmit upstream data signals on channel 17. The upstream data signals are generally passed to video source 12 via channel 17, transceiver 16, transmission apparatus 14, and first cable 20.

VTA 14 may include multiple active devices in the form of active video equipment, transmission links, individual amplifiers and/or buffers. VTA 14 may include an active device 25 that can include active video equipment, a transmission link, and/or one or more amplifiers. For example, active device 25 can include a fiber optic link and/or a motion detector. VTA 14 may also include other active devices, such as an individual driving amplifier 24 for amplifying and transmitting active video signals and downstream data signals to video receiver 18. In one embodiment, amplifier 24 has a gain of two.

Active device 25 includes an input 27 and an output 29. Similarly, amplifier 24 includes an input 26 and an output 28. Amplifier 24 and active device 25 are generally one-way active devices in that they pass active-device-signals in only one direction. For instance, amplifier 24 receives signals on input 26 and transmits or otherwise passes the signals from input 26 as amplified active-device-signals on output 28. Amplifier 24 also blocks signals received on output 28 from being transmitted on input 26. That is, amplifier 24 prevents signals from passing through amplifier 24 in a reverse direction from output 28 to input 26. Thus, amplifier 24 transmits signals only on its output 28. Similarly, active device 25 receives signals on input 27 and transmits or otherwise passes the signals from input 27 as active-device-signals on output 29. Active device 25 also blocks signals received on output 29 from being transmitted on input 27. That is, active device 25 prevents signals from passing through active device 25 in a reverse direction from output 29 to input 27. Thus, active device 25 transmits signals only on its output 29.

VTA 14 includes a first port 30 that is electrically connected to video source 12 and its associated transceiver through coaxial cable 20. VTA 14 also includes a second port 32 that is electrically connected to video receiver 18 through transceiver 16, channel 17 and coaxial cable 22. One or both of ports 30, 32 can be in the form of a serial port having only a single conductive conduit for carrying signals.

VTA 14 includes bypass circuitry 34 for bypassing one-way active devices 24, 25 to thereby allow data signals from video receiver 18 to be transmitted in an upstream direction to video source 12. Bypass circuitry 34 transmits upstream data signals from second port 32 to first port 30 such that the upstream data signals bypass, i.e., circumvent, one-way active devices 24, 25.

Bypass circuitry 34 includes a data extraction section 36, a data insertion section 38, and a synchronization device 31. Data insertion section 36 has a first input 40 electrically connected to an output 29 of active device 25 and to an input 26 of amplifier 24. Data extraction section 36 also has a second input 44 electrically connected to output 28 of amplifier 24 and to second port 32. An output 46 of data extraction section 36 is selectively electrically connected to an input 48 of data insertion section 38 via a switch 33 controlled by synchronization device 31. Switch 33 can be physically embodied by a conventional switch, a relay, a transistor-type device, or an integrated circuit, such as a multiplexer, for example. Data insertion section 38 has an input/output 54 electrically connected to first port 30. Data insertion section 38 also has an output 42 electrically connected to input 27 of active device 25.

Data extraction section 36 includes a bypass amplifier 58 and a subtractor 60. Amplifier 58 provides a signal propagation delay substantially equal to that of amplifier 24 to facilitate the operation of subtractor 60. Bypass amplifier 58 may be an active one-way device that functions substantially the same as amplifier 24, as described above. Thus, the characteristics of bypass amplifier 58 will not be discussed in further detail herein. Data insertion section 38 includes an output adder 64, and a subtractor 66.

Synchronization device 31 includes a video sync separator 35, a video line counter 37 and a data window decoder 39. An input 41 of separator 35 is electrically connected to input/output 54. An output 43 of video sync separator 35 is electrically connected or coupled to an input 45 of video line counter 37. An output 47 of video line counter 37 is electrically connected or coupled to an input 49 of data window decoder 39. Data window decoder 39 is coupled to switch 33 such that decoder 39 can open and close switch 33 to thereby selectively bring output 46 and input 48 into electrical communication.

Transceiver 16 receives the video output signal via port 32 and extracts the active video signals and/or downstream data signals therefrom. Transceiver 16 can transmit the active video signals to video receiver 18 on transmission line 22 and can transmit the downstream data signals to video receiver 18 on communications channel 17. Video receiver 18 can transmit upstream data signals to transceiver 16 on communications channel 17. Transceiver 16 can also insert the upstream data signals received from video receiver 18 on port 32.

Video receiver 18 may include a control system 68 and a video sink in the form of a monitor 70. Control system 68 may include a video switcher, a multiplexer and/or a driver (not shown). Control system 68 may process the active video signals that control system 68 receives on second coaxial cable 22 as well as the downstream data signals that control system 68 receives on channel 17. Control system 68 may then transmit the processed active video signals to monitor 70 for visual display on the screen of the monitor. Control system 68 may also create upstream data signals based, at least in part, upon the active video signals and downstream data signals that control system 68 receives. Further, control system 68 may transmit the upstream data signals on channel 17.

In operation, video source 12 transmits active video signals and downstream data signals to VTA 14, which inputs the signals into active device 25. Video receiver 18 transmits upstream data signals to VTA 14, which selectively inputs the upstream signals into adder 64 and subtractor 66. The output of active device 25 is fed into input 26 of amplifier 24. Amplifier 24 amplifies the active video signals and downstream data signals for transmission to video receiver 18. That is, amplifier 24 transmits, on output 28, signals that are dependent upon the signals received on input 26. These amplified video output signals are separated by transceiver 16 into active video signals and downstream data signals, and transmitted on coaxial cable 22 and channel 17, respectively, to video receiver 18.

The simultaneous transmission of active video signals and downstream data signals by amplifier 24 and transmission of corresponding upstream data signals by video receiver 18 results in both sets of signals being simultaneously present at port 32 and at second input 44. Thus, a single port 32 is used to transmit both downstream-directed signals and upstream-directed signals.

Subtractor 60 subtracts out the active video signal and downstream data signals from the signals received at second input 44, thereby leaving only, i.e., extracting, the corresponding upstream data signals to be transmitted on output 46. Synchronization device 31 operates switch 33 such that the upstream data signals on output 46 are not transmitted to or carried on cable 20 during time periods in which active video signals are transmitted to or carried on cable 20. Thus synchronization device 31 prevents the upstream data signals from interfering with the active video signals and thereby distorting the image that is displayed on monitors 19, 70 and that is based upon the active video signals.

Synchronization device 31 identifies time periods in which portions of the video source output signal that contain the active video signals are received by first port 30 and time periods in which portions of the video source output signal that contain the downstream data signals are received by first port 30. Generally, when portions of the video source output signal containing the active video signals are received by first port 30, decoder 39 of synchronization device 31 places switch 33 in its open position so that upstream data signals cannot interfere with the active video signals. When portions of the video source output signal containing the downstream data signals are received by first port 30, synchronization device 31 places switch 33 in its closed position so that upstream data signals can also reach first port 30.

In determining which portions of the video source output signal are being received by first port 30, video sync separator 35 extracts synchronization information from the video source output signal on input 41. Video line counter 37 receives the synchronization information from the output signal and calculates a video line count based thereon. When the video line count is within a predetermined range of values within each field, then downstream data signals may be transmitted on port 30. Active video signals may be transmitted on port 30 when the video line count is within another set of values. It is also possible for neither downstream data signals nor active video signals to be transmitted on port 30 when the video line count is within yet another set of values.

Data window decoder 39 receives the video line count from video line counter 37 and controls the opening and closing of switch 33 based thereon. More particularly, if the video line count indicates that active video signals are being received by first port 30, then data window decoder 39 maintains switch 33 in its open position so that upstream data signals do not interfere with or corrupt the active video signals. Else, if the video line count indicates that active video signals are not being received by first port 30, then data window decoder 39 may maintain switch 33 in its closed position so that upstream data signals may reach video source 12.

When switch 33 is closed, the upstream data signals from adder 64 are transmitted on coaxial cable 20 to video source 12. The transmission of active video signals and downstream data signals by video source 12 and transmission of upstream data signals by adder 64 results in both sets of signals being carried by coaxial cable 20 and being present at input/output 54. Thus, similarly to port 32 at the output of VTA 14, a single transmission line 20 and a single port 30 are used to transmit both downstream-directed signals and upstream-directed signals at the input of VTA 14. Subtractor 66 subtracts out the upstream data signals from the signals received at input/output 54, thereby leaving only the active video signals and downstream data signals to be transmitted to active device 25, as mentioned above. Subtracting out the upstream data signals in subtractor 66 may be necessary in order to prevent collision of two sets of corresponding upstream data signals at the second inputs 44 of data extraction section 36.

In the embodiment shown above, bypass circuitry 34 is used to bypass both active device 25 and amplifier 24. However, if active device 25 were not included in the video system, i.e., if active device 25 were replaced in FIG. 1 by a non-active element such as a transmission line, then bypass circuitry 34 would still be needed in order to bypass amplifier 24.

If amplifier 24 were not needed to amplify the signals to video receiver 18, such as if active device 25 included an adequate amplifying device, then amplifier 24 may still be used to create the upstream data signal on output 46. Thus, in this case, amplifier 24 would function as a part of bypass circuitry 34. Alternatively, if the amplifying properties of amplifier 24 were not needed, then amplifier 24 could be replaced in FIG. 1 by a non-active element such as a transmission line, and first input 40 of data extraction section 36 could be electrically connected to input 27 of active device 25 rather than to output 29.

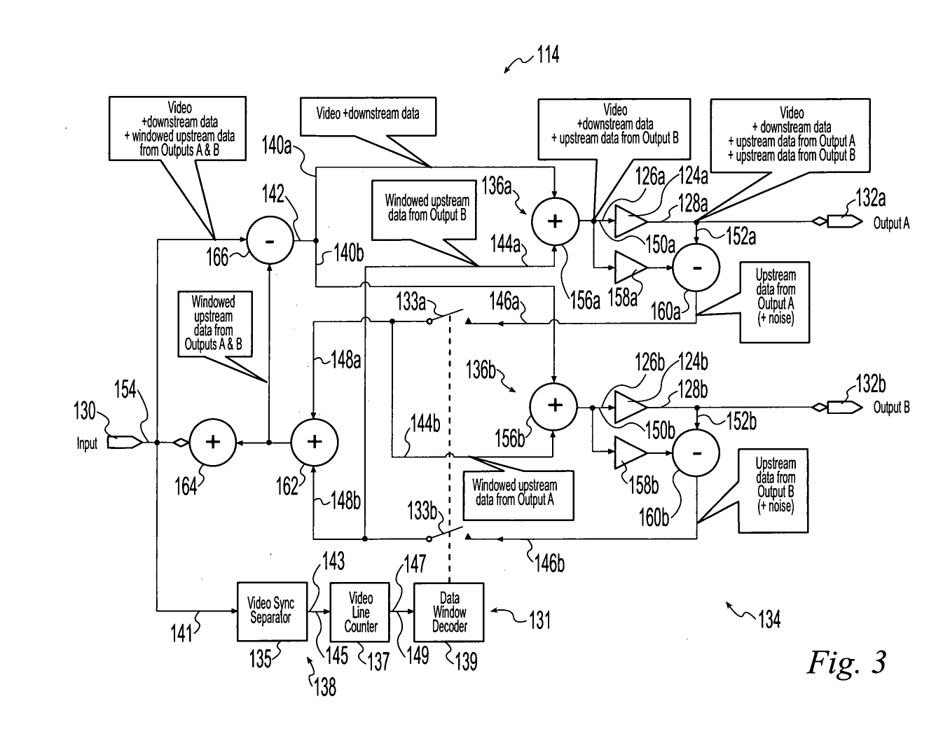

Another embodiment of a VTA of the present invention is shown in FIG. 3. In this embodiment, the VTA is in the form of what is commonly referred to as a video distribution amplifier (VDA). VDA 114 has a single input port 130 which may be connected to a first coaxial cable leading to a video source, such as cable 20 and video source 12 of video system 10. VDA 114 also has two output ports 132a, 132b, which may be connected to respective transceivers, communications channels and second coaxial cables leading to respective video receivers, such as transceiver 16, channel 17, cable 22 and video receiver 18 of video system 10. Thus, VDA 114 connects a single video source with multiple, e.g., two, video receivers. VDA 114 also connects output ports 132a, 132b with each other such that upstream data signals from each video receiver can be transmitted to the other one of the two video receivers as well as to the video source.

The active video signals and downstream data signals are generally passed from input port 130 to output ports 132a, 132b via distribution apparatus 114. The upstream data signals are generally passed from an output port to input port 130 and to the output port other than the output port that originates the upstream data signal. For example, upstream data signals from output port 132a are passed to input port 130 and to output port 132b. Similarly, upstream data signals from output port 132b are passed to input port 130 and to output port 132a.

Despite itself being referred to as an “amplifier”, a video distribution amplifier such as VDA 114 may include multiple active devices in the form of individual amplifiers or buffers. VDA 114 includes such individual driving amplifiers 124a and 124b for amplifying and transmitting active video signals, downstream data signals and selected upstream data signals to output ports 132a, 132b, respectively. More particularly, amplifier 124a amplifies and transmits active video signals, downstream data signals and upstream data signals from output port 132b to output port 132a. Similarly, amplifier 124b amplifies and transmits active video signals, downstream data signals and upstream data signals from output port 132a to output port 132b. In one embodiment, amplifiers 124a , 124b each have a gain of two.

Amplifiers 124a, 124b include respective inputs 126a, 126b and respective outputs 128a, 128b. Amplifiers 124a, 124b are generally one-way active devices in that they pass active-device-signals in only one direction. For instance, amplifier 124a receives signals on input 126a and transmits or otherwise passes the signals from input 126a as amplified signals on output 128a. Amplifier 124a also blocks signals received on output 128a from being transmitted on input 126a. That is, amplifier 124a prevents signals from passing through amplifier 124a in a reverse direction from output 128a to input 126a. Thus, amplifier 124a transmits signals only on its output 128a. Similarly, amplifier 124b receives signals on input 126b and transmits or otherwise passes the signals from input 126b as amplified signals on output 128b. Amplifier 124b also blocks signals received on output 128b from being transmitted on input 126b. That is, amplifier 124b prevents signals from passing through amplifier 124b in a reverse direction from output 128b to input 126b. Thus, amplifier 124b transmits signals only on its output 128b.

VDA 114 includes bypass circuitry 134 for bypassing one-way amplifiers 124a, 124b to thereby allow data signals from output ports 132a, 132b to be transmitted in an upstream direction to input port 130 and to the other one of output ports 132a, 132b. Bypass circuitry 134 transmits upstream data signals from output ports 132a, 132b to input port 130 and to inputs 126a, 126b of amplifiers 124a, 124b such that the upstream data signals bypass, i.e., circumvent, one-way amplifiers 124a, 124b. More particularly, bypass circuitry 134 transmits upstream data signals from each of output ports 132a, 132b to input port 130 and to the input of the amplifier not corresponding to the output port from which the upstream data signal originates. For example, bypass circuitry 134 transmits upstream data signals from output port 132a to input port 130 and to input 126b of amplifier 124b. In the embodiment of FIG. 3, bypass circuitry 134 does not transmit upstream data signals from output port 132a to input 126a of amplifier 124a, which amplifier corresponds to the output port 132a from which the upstream data signals originate. Similarly, bypass circuitry 134 transmits upstream data signals from output port 132b to input port 130 and to input 126a of amplifier 124a, but not to input 126b of amplifier 124b.

Bypass circuitry 134 includes receiver-specific sections 136a, 136b, a common section 138, and a synchronization device 131. Receiver-specific sections 136a, 136b have respective first inputs 140a, 140b each electrically connected to an output 142 of common section 138. Receiver-specific sections 136a, 136b also have respective second inputs 144a, 144b each selectively electrically connected, via respective switches 133b, 133a, to respective first outputs 146b, 146a of the other one of the receiver-specific sections 136a, 136b. Switches 133a, 133b may be controlled by synchronization device 131 and can be physically embodied by conventional switches, relays, transistor-type devices, or integrated circuits, such as multiplexers, for example. First outputs 146a, 146b are also selectively electrically connected to respective inputs 148a, 148b of common section 138 via respective switches 133a, 133b. Second outputs. 150a, 150b of receiver-specific sections 136a, 136b are electrically connected to respective amplifier inputs 126a, 126b. Third inputs 152a, 152b of receiver-specific sections 136a, 136b are electrically connected to respective amplifier outputs 128a, 128b and to respective output ports 132a, 132b. Common section 138 has an input/output 154 electrically connected to input port 130.

Receiver-specific sections 136a, 136b include respective adders 156a, 156b, bypass amplifiers 158a, 158b, and subtractors 160a, 160b. Bypass amplifiers 158a, 158b may be active one-way devices that function substantially the same as amplifiers 124a, 124b, as described above. Thus, the characteristics of bypass amplifiers 158a, 158b will not be discussed in further detail herein. Common section 138 includes an input adder 162, an output adder 164, and a subtractor 166.

Synchronization device 131 includes a video sync separator 135, a video line counter 137 and a data window decoder 139. An input 141 of separator 135 is electrically connected to input/output 154. An output 143 of video sync separator 135 is electrically connected or coupled to an input 145 of video line counter 137. An output 147 of video line counter 137 is electrically connected or coupled to an input 149 of data window decoder 139. Data window decoder 139 is coupled to switches 133a, 133b such that decoder 139 can open and close switches 133a, 133b to thereby selectively bring output 146 and input 148 into electrical communication.

In operation, VDA 114 inputs active video signals and downstream data signals from input port 130 into each of adders 156a, 156b. VDA 114 also inputs each of the upstream signals from output ports 132a, 132b into the one of the adders 156a, 156b that does not correspond to the output port from which the upstream signals originate. For example, VDA 114 inputs upstream signals from output port 132a into adder 156b, and inputs upstream signals from output port 132b into adder 156a. The outputs of adders 156a, 156b are fed into respective inputs 126a, 126b of amplifiers 124a, 124b. Amplifiers 124a, 124b amplify the active video signals, downstream data signals and upstream data signals for transmission to corresponding output ports 132a, 132b. That is, amplifiers 124a, 124b transmit on outputs 128a , 128b signals that are dependent upon the signals received on inputs 126a, 126b. These amplified output signals are transmitted to output ports 132a, 132b, and may be further transmitted on respective coaxial cables to respective video receivers.

The transmission of active video signals, downstream data signals, and non-corresponding upstream data signals by amplifier 124a and transmission of corresponding upstream data signals from output port 132a results in both sets of signals being carried by and present at output port 132a and at third input 152a. Thus, a single output port 132a carries both downstream-directed signals and upstream-directed signals. Similarly, the transmission of active video signals, downstream data signals, and non-corresponding upstream data signals by amplifier 124b and transmission of corresponding upstream data signals from output port 132b results in both sets of signals being carried by and present at output port 132b and at third input 152b.

Subtractors 160a, 160b subtract out the active video signals, downstream data signals, and non-corresponding upstream data signals from the signals received at third inputs 152a, 152b, thereby leaving only, i.e., extracting, the corresponding upstream data signals to be transmitted on first outputs 146a, 146b. In addition to being received at the non-corresponding one of adders 156a, 156b, as mentioned above, the upstream data signals are collected and summed at adder 162. The output of adder 162 is transmitted both to adder 164 and to subtractor 166.

Synchronization device 131 identifies time periods in which portions of the video source output signal that contain the active video signals are received by input port 130 and time periods in which portions of the video source output signal that contain the downstream data signals are received by input port 130. Generally, when portions of the video source output signal that contain the active video signals are received by input port 130, decoder 139 of synchronization device 131 places switches 133a, 133b in their open positions so that upstream data signals cannot interfere with the active video signals. When portions of the video source output signal containing the downstream data signals are received by input port 130, decoder 139 of synchronization device 131 places switches 133a, 133b in their closed position so that upstream data signals can also reach input port 130.

In determining which portions of the video source output signal are being received by input port 130, video sync separator 135 extracts synchronization information from the video source output signal on input 141. Video line counter 137 receives the synchronization information from the output signal and calculates a video line count based thereon. When the video line count is within a predetermined range of values within each field, then downstream data signals may be transmitted on input port 130. Active video signals may be transmitted on input port 130 when the video line count is within another set of values. It is also possible for neither downstream data signals nor active video signals to be transmitted on input port 130 when the video line count is within yet another set of values.

Data window decoder 139 receives the video line count from video line counter 137 and controls the opening and closing of switches 133a, 133b based thereon. More particularly, if the video line count indicates that active video signals are being received by input port 130, then data window decoder 139 maintains switches 133a, 133b in their open positions so that upstream data signals do not interfere with or corrupt the active video signals. Else, if the video line count indicates that active video signals are not being received by input port 130, then data window decoder 139 may maintain switches 133a, 133b in their closed positions so that upstream data signals may reach input port 130.

In one embodiment, decoder 139 maintains switches 133a, 133b in the same positions, i.e., opens switches 133a, 133b at the same time or simultaneously and closes switches 133a, 133b at the same time or simultaneously. However, it is also possible for decoder 139 to independently control switches 133a, 133b such that switches 133a, 133b may at least occasionally be in different positions.

When switches 133a, 133b are closed, the summed upstream data signals from adder 164 are transmitted to input port 130. The transmission of active video signals and downstream data signals from input port 130 and transmission of upstream data signals by adder 164 results in both sets of signals being carried by and present at input port 130 and at input/output 154. Thus, as at the outputs of VDA 114, a single input port 130 is used to carry both downstream-directed signals and upstream-directed signals at the input of VDA 114. Subtractor 166 subtracts out the upstream data signals from the signals received at input/output 154, thereby leaving only the active video signals and downstream data signals to be transmitted to adders 156a, 156b, as mentioned above. Subtracting out the upstream data signals in subtractor 166 may be necessary in order to prevent collision of two sets of corresponding upstream data signals at the third inputs 152a, 152b of receiver-specific sections 136a, 136b.

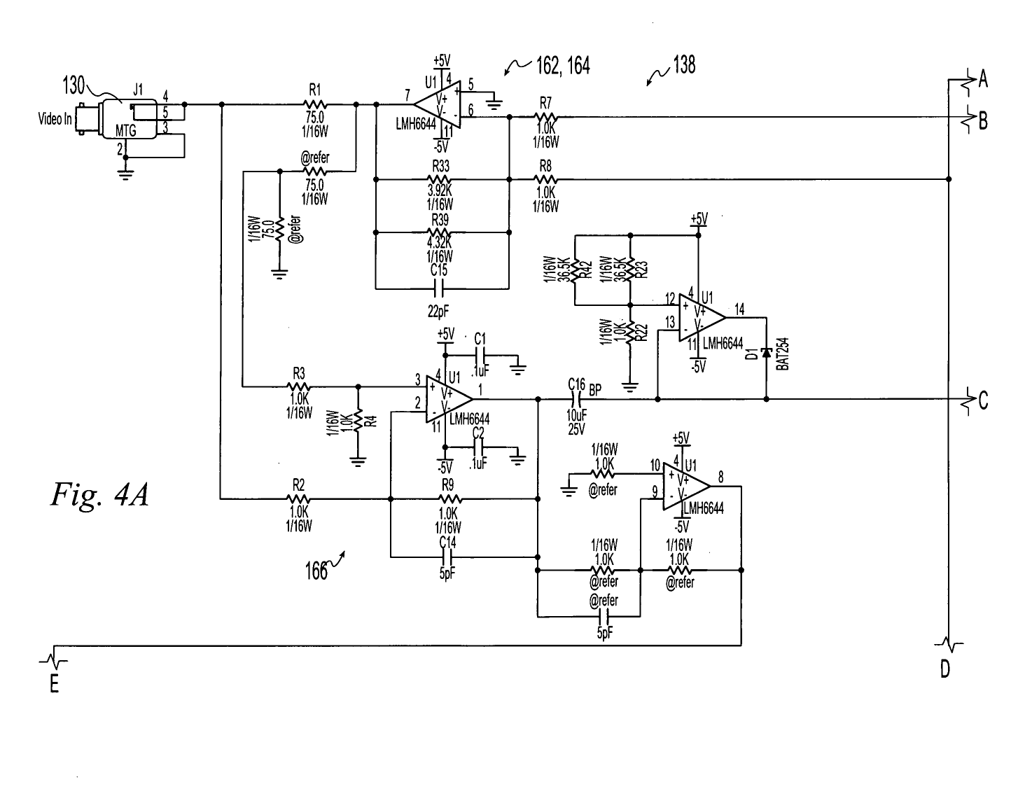

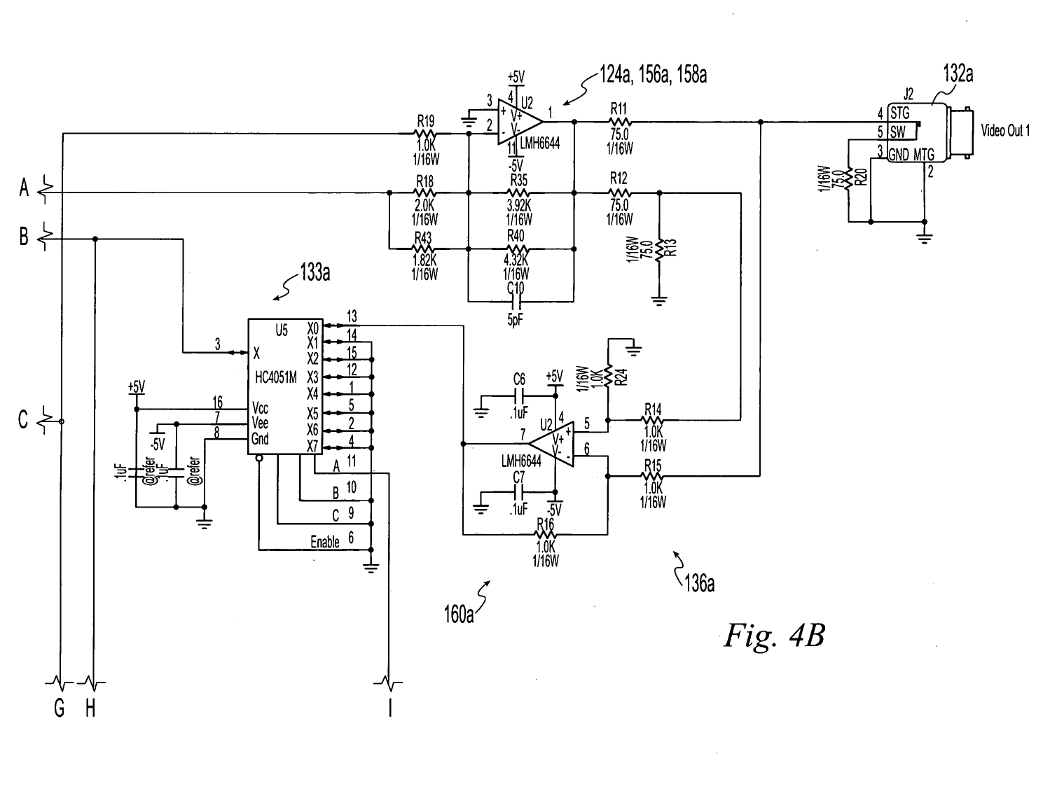

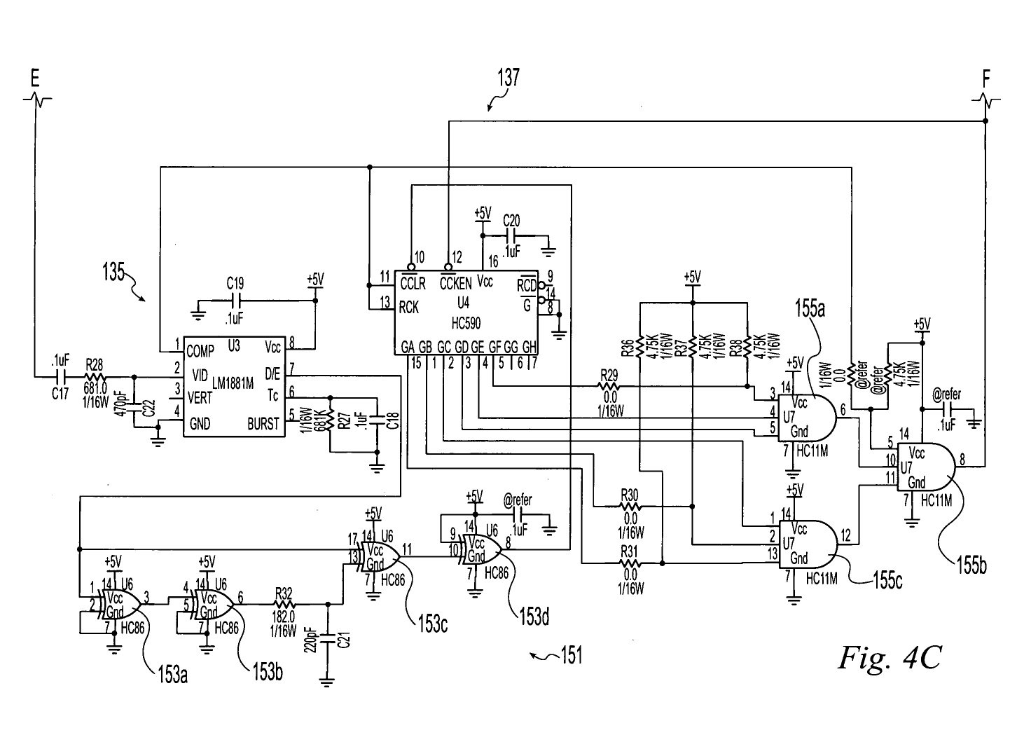

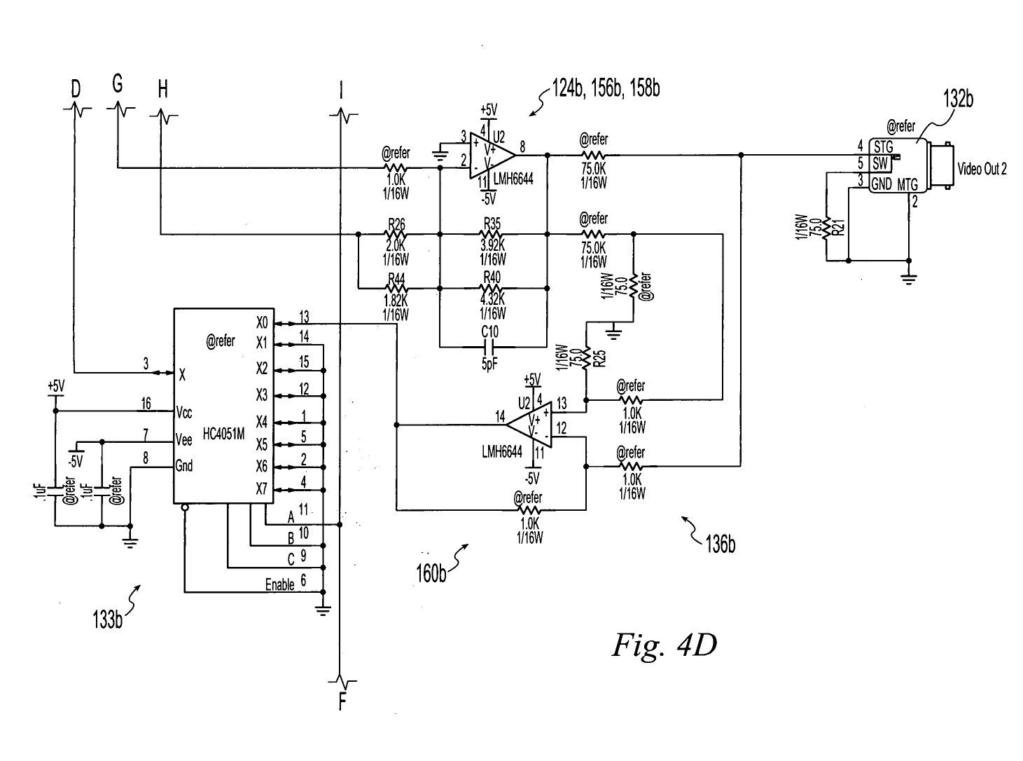

One specific embodiment of VDA 114 is shown in FIGS. 4A-4D. One embodiment of a portion of common section 138 is depicted in FIG. 4A. VDA 114 may include an input port 130 in the form of a coaxial cable connector. Adders 162, 164 may be in the form of a model LMH6644 amplifier produced by National Semiconductor Corporation, and its associated connected circuitry, including discrete components such as various resistors and capacitors. Subtractor 166 may be in the form of another LMH6644 amplifier and its associated circuitry. The third amplifier shown in FIG. 4A, with its output leading to reference letter C, is arranged as an inverter performing a video clamp function, and has no corresponding function block in FIG. 3. The fourth amplifier shown in FIG. 4A, with its output leading to reference letter E, readies the video source output signal for processing by video sync separator 135 of synchronization device 131.

One embodiment of first receiver-specific section 136a and switch 133a is depicted in FIG. 4B. VDA 114 may include an output port 132a in the form of a second coaxial cable connector. Adder 156a and amplifiers 124a, 158a may be embodied in a fifth LMH6644 amplifier and its associated circuitry. Subtractor 160a may be in the form of a sixth LMH6644 amplifier and its associated circuitry. Switch 133a may be in the form of model HC4051M high speed CMOS logic analog multiplexer/demultiplexer sold by Texas Instruments Incorporated, and its associated circuitry, including discrete components such as various resistors and capacitors.

One embodiment of synchronization device 131 is depicted in FIG. 4C. Video sync separator 135 can be in the form of a model LM1881M video sync separator produced by National Semiconductor Corporation, and its associated connected circuitry, including discrete components such as various resistors and capacitors. Video line counter 137 may be in the form of a model HC590 8-bit binary counter with 3-state output register sold by Texas Instruments Incorporated, and its associated connected circuitry, including discrete components such as various resistors and capacitors. A circuit 151 including exclusive OR gates 153a, 153b, 153c, 153d may be provided to reset the counter at the beginning of each field, wherein there are two interleaved fields per screen as displayed on a monitor. Data window decoder 139 may be in the form of AND gates 155a, 155b, 155c and their associated connected circuitry, including discrete components such as various resistors and capacitors.

Finally, one embodiment of second receiver-specific section 136b and switch 133b is depicted in FIG. 4D. VDA 14 may include an output port 132b in the form of a third coaxial cable connector. Adder 156b and amplifiers 124b, 158b may be embodied in a seventh LMH6644 amplifier and its associated circuitry. Subtractor 160b may be in the form of an eighth LMH6644 amplifier and its associated circuitry. Switch 133b may be in the form of a second model HC4051M high speed CMOS logic analog multiplexer/demultiplexer sold by Texas Instruments Incorporated, and its associated circuitry, including discrete components such as various resistors and capacitors.

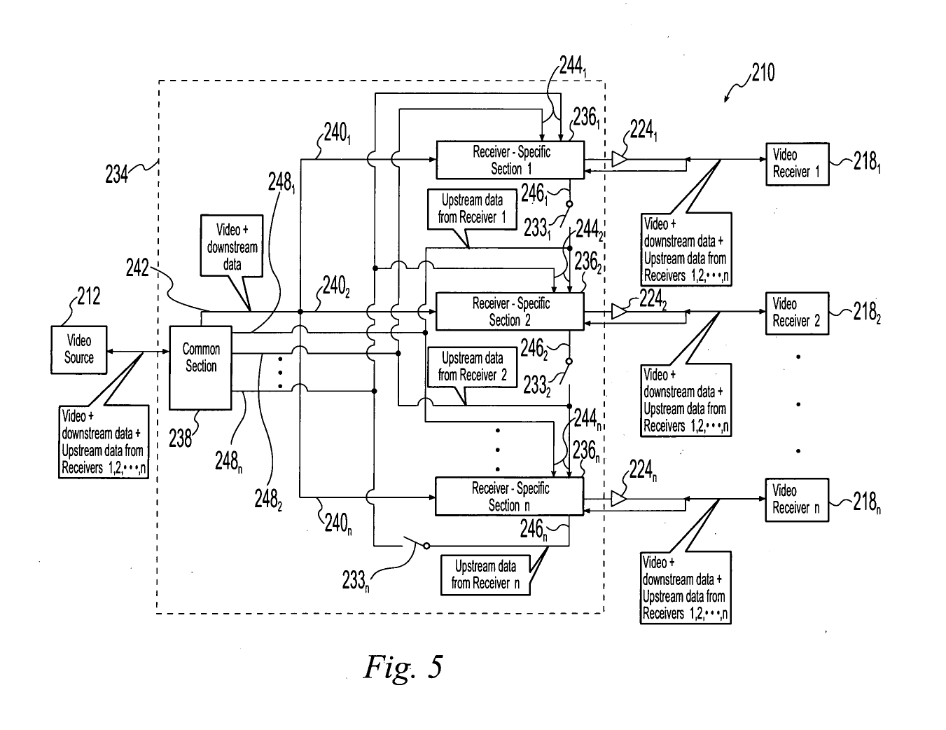

In the embodiment described above with reference to FIGS. 3 and 4A-4D, VDA 114 can be used with a video system that includes two video receivers. However, it can be readily appreciated by one of skill in the art that the present invention can be easily applied to a video system having any number of video receivers. A simplified block diagram of the general case of a video system 210 having n number of video receivers 218₁, 218₂, . . . , 218ₙ is shown in FIG. 5. The driving amplifiers and the receiver-specific sections of the bypass circuitry may be replicated for each additional receiver. Thus, video system 210 includes amplifiers 224₁, 224₂, . . . 224ₙ, and bypass circuitry 234 includes receiver-specific sections 236₁, 236₂, . . . , 236ₙ. The first outputs 246₁, 246₂, . . . , 246ₙ of all n number of receiver-specific sections may be selectively connected to the second inputs 244₁, 244₂, . . . , 244ₙ of all other receiver-specific sections, and to inputs 248₁, 248₂, . . . , 248ₙ of a common section 238, via switches 233₁, 233₂, . . . 233ₙ. The positions of switches 233₁, 233₂, . . . , 233ₙ can be controlled by a synchronization device within common section 238. Finally, the output 242 of common section 238 may be connected to first inputs 240₁, 240₂, . . . , 240ₙ of all of the receiver-specific sections. Thus, any number of video receivers 218 may be in bidirectional communication with a single video source 212 and with each other.

In the embodiments described above, upstream data signals are not sent to the input of the amplifier that corresponds to the video receiver from which the upstream data signal originates. However, it is to be understood that it is also possible, within the scope of the present invention, for upstream data signals to be sent to the inputs of all amplifiers, including the amplifier that corresponds to the video receiver from which the upstream data signal originates. In this case, the upstream data signal could be subtracted out of both the output of the corresponding driving amplifier and the output of the corresponding bypass amplifier.

While this invention has been described as having an exemplary design, the present invention may be further modified within the spirit and scope of this disclosure. This application is therefore intended to cover any variations, uses, or adaptations of the invention using its general principles.

1. A video system, comprising:
a video source operable to transmit an output signal on a transmission line, the output signal having a format such that first portions of the output signal include active video signals and second portions of the output signal lack active video signals;
a plurality of video receivers, each said receiver being operable to display images based upon the active video signals and to transmit a respective data signal on a respective one of a plurality of ports; and
a distribution device electrically connected to said transmission line and to each of said ports, said distribution device being operable to transmit each of the data signals to said video source on said transmission line only during time periods when the second portions of the output signal are being transmitted on said transmission line, said distribution device including a plurality of amplifiers, each said amplifier having an input and an output, each said amplifier being operable to receive signals on said input for transmission on said output as amplified signals, each said amplifier being operable to block signals received on said output from being transmitted on said input, each said amplifier being operable to transmit a respective said amplified signal to a respective one of said receivers on a respective one of said ports, each of the amplified signals being dependent upon the output signal and upon a data signal transmitted on said transmission line from the receivers other than said respective receiver.

2. The system of claim 1 wherein the data signals transmitted by said receivers comprise upstream data signals, the second portions of the output signal comprising downstream data signals, said video source being operable to transmit the output signal on said transmission line, each said amplified signal being dependent upon the active video signal, the downstream data signal, and an upstream data signal from a receiver other than said respective receiver.

3. The system of claim 1 wherein each said amplified signal is dependent upon the output signal and upon each of the data signals from the receivers other than said respective receiver.

4. The system of claim 1 wherein each said amplifier comprises a one-way active device that transmits signals only on its output.

5. The system of claim 1 wherein said distribution device includes bypass circuitry operable to transmit the data signals from each of the receivers to the transmission line and to the inputs of said amplifiers such that the data signals bypass said amplifiers.

6. The system of claim 5 wherein said bypass circuitry is operable to transmit the data signals from each of the receivers to the transmission line and to the inputs of all of said amplifiers not corresponding to said receiver from which said data signal originates.

7. The system of claim 1 wherein said transmission line comprises a coaxial cable.

8. A video system, comprising:
a video source operable to transmit an output signal on a transmission line, the output signal having a format such that first portions of the output signal include active video signals and second portions of the output signal lack active video signals;
a plurality of video receivers, each said receiver being operable to display images based upon the active video signals and to transmit a respective data signal on a respective port; and
a distribution device in electrical communication with said transmission line and with each of said second transmission lines, said distribution device being operable to transmit each of the data signals to said video source on said transmission line only during time periods when the second portions of the output signal are being transmitted on said transmission line, said distribution device including a plurality of active devices, each said active device being operable to transmit a respective active-device-signal to a respective one of said receivers on a respective one of said ports, each of the active-device-signals being dependent upon the output signal and upon at least one of the data signals transmitted on said transmission line from the receivers other than said respective receiver.

9. The system of claim 8 wherein each said active device has an input and an output, each said active device being operable to pass signals from said input to said output and to prevent signals from passing through said active device from said output to said input.

10. The system of claim 8 wherein the data signals transmitted by said receivers comprise upstream data signals, the second portions of the output signal comprising downstream data signals, said video source being operable to transmit the output signal on said transmission line, each said active-device-signal being dependent upon the output signal, the downstream data signal, and an upstream data signal from the receivers other than said respective receiver.

11. The system of claim 8 wherein each said active-device-signal is dependent upon the output signal and upon each of the data signals from the receivers other than said respective receiver.

12. The system of claim 8 wherein each said active device comprises a one-way active device that transmits signals only on its output.

13. The system of claim 8 wherein said distribution device includes bypass circuitry operable to transmit the data signals from each of the receivers to said transmission line and to respective inputs of said active devices such that the data signals bypass said active devices.

14. The system of claim 13 wherein said bypass circuitry is operable to transmit the data signals from each of the receivers to said transmission line and to the inputs of all of said amplifiers not corresponding to said receiver from which said data signal originates.

15. The system of claim 8 wherein said transmission line comprises a coaxial cable.

16. A video distribution apparatus, comprising:
a first port configured to be electrically connected to a video source and to receive an output signal from the video source, the output signal having a format such that first portions of the output signal include active video signals and second portions of the output signal lack active video signals;
a plurality of second ports, each said second port being configured to be electrically connected to a respective video receiver;
a plurality of active devices, each said active device having an input and an output, each said output being electrically connected to a corresponding one of said second ports, each said input being configured to receive the output signal from the video source via said first port; and
bypass circuitry including a synchronization device operable to identify when the first portions of the output signal are received by said first port and when the second portions of the output signal are received by said first port, said bypass circuitry being operable to transmit data signals from each of said second ports to said first port and to said inputs of said active devices such that:
the data signals bypass said active devices;
the first portions of the output signal are received by said first port during first periods in time, the data signals are received by said first port during second periods in time, the first periods in time and the second periods in time being mutually exclusive; and
the first portions of the output signal are received by said inputs of said active devices during third periods in time, the data signals are received by said inputs of said active devices during fourth periods in time, the third periods in time and the fourth periods in time being mutually exclusive.

17. The apparatus of claim 16 wherein said bypass circuitry is operable to transmit data signals from each of the second ports to the first port and to the inputs of all of said amplifiers not corresponding to said second port from which said data signal originates.

18. The system of claim 16 wherein each said active device is operable to pass signals from said input to said output and to prevent signals from passing through said active device from said output to said input.

19. The system of claim 16 wherein the data signals from said second ports comprise upstream data signals, each said input of said active devices being configured to receive the active video signals and downstream data signals from the video source via said first port, each said active device being operable to transmit active-device-signals dependent upon the active video signals, the downstream data signals, and the upstream data signals.

20. The system of claim 16 wherein each said active device comprises a one-way active device that transmits signals only on its output.

21. The system of claim 16 wherein said bypass circuitry is operable to transmit the data signals from each of the second ports to the first port and to the inputs of only said active devices other than said active device that corresponds to said second port from which said data signal originates.

22. The system of claim 16 wherein the first periods in time correspond to the third periods in time, and the second periods in time correspond to the fourth periods in time.

23. The system of claim 16 wherein said synchronization device includes:
a video sync separator operable to extract synchronization information from the output signal;
a video line counter coupled to said video sync separator and operable to receive the synchronization information from the output signal and calculate a video line count; and
a data window decoder coupled to said video line counter and operable to:
prevent the data signals from being received by said first port during the first periods in time; and
prevent the data signals from being received by said inputs of said active devices during the third periods in time.

24. A video distribution apparatus, comprising:
a first port configured to be electrically connected to a video source and to receive an output signal from the video source, the output signal having a format such that first portions of the output signal include active video signals and second portions of the output signal lack active video signals;
a second port configured to be electrically connected to a video receiver;
an active device having an input and an output, said output being electrically connected to said second port, said input being configured to receive the output signal from the video source via said first port; and
bypass circuitry including a synchronization device operable to identify when the first portions of the output signal are received by said first port and when the second portions of the output signal are received by said first port, said bypass circuitry being operable to transmit data signals from said second port to said first port such that:
the data signals bypass said active device; and
the first portions of the output signal are received by said first port during first periods in time, the data signals are received by said first port during second periods in time, the first periods in time and the second periods in time being non-overlapping.

25. The system of claim 24 wherein said active device comprises a one-way active device that transmits signals only on its output.

26. The apparatus of claim 24 wherein said synchronization device includes:
a video sync separator operable to extract synchronization information from the output signal;
a video line counter coupled to said video sync separator and operable to receive the synchronization information from the output signal and calculate a video line count; and
a data window decoder coupled to said video line counter and operable to prevent the data signals from being received by said first port during the first periods in time.
